(19) United States
(12) Patent Application Publication
(10) Pub. No.: US 2016/0234009 A1
(43) Pub. Date: Aug. 11, 2016

(54) Chaotic Baseband Modulation Hopping Based Post-Quantum Physical-Layer Encryption

(71) Applicants: Wenhua Li, Auburndale, MA (US); Min Xu, Auburndale, MA (US)

(72) Inventors: Wenhua Li, Auburndale, MA (US); Min Xu, Auburndale, MA (US)

(21) Appl. No.: 14/976,373

(22) Filed: Dec. 21, 2015

Related U.S. Application Data
(60) Provisional application No. 62/113,462, filed on Feb. 8, 2015.

(51) Int. Cl. H04L 9/00; H04L 29/08

(52) U.S. Cl. CPC H04L 9/001; H04L 69/323

(57) ABSTRACT

A post-quantum physical-layer encryption/decryption system based on chaotic Baseband Modulation Hopping (BMH). The baseband constellation, mapping, power level, and phase will vary symbol-by-symbol according to assigned random sequences. Pre-shared secret keys are used as the chaotic system parameters, initialization, and quantization parameters to generate the BMH codes. The BMH physical-layer encryption/decryption system can be combined with digital-domain based encryption algorithms such as AES, code-based post-quantum cryptography, and other physical-layer secure communication techniques such as Frequency Hopping (FH) and Direct Sequence Spread Spectrum (DSSS). It can also be combined with Quantum Key Distribution (QKD) to provide mutual authenticated key distribution. This invention can be applied to all kinds of communication systems including wireless (radio frequency, optical, quantum channel, sonar) and wire (optical fiber, power-line, telephone line, wire quantum channel, etc.), single carrier and multi-carrier, OFDM, MIMO channels.

### RELATED U.S. APPLICATION DATA

Provisional application No. 62/113,462, filed on Feb. 8, 2015.

### STATEMENT REGARDING FEDERALLY SPONSORED RESEARCH OR DEVELOPMENT

Not Applicable.

### REFERENCE CITED

### U.S. Patent Documents

U.S. Pat. No. 0,208,893 A1 August 2010 Morio Toyoshima et al.

U.S. Pat. No. 0,131,454 A1 February 2008 Ingrid Verbauwhede

U.S. Pat. No. 0,157,872 A1 July 2005 Takatoshi Ono et al.

U.S. Pat. No. 7,218,735 B2 May 2007 Jean-sebastien Coron

### Other Publications

Song Y. Yang, Cryptanalytic Attacks on RSA, Springer, 2007.

Daniel J. Bernstein, Post-Quantum Cryptography, Springer, 2009.

Peter W. Shor, Polynomial-Time Algorithms for Prime Factorization and Discrete Logarithms on a Quantum Computer, Proceedings of the 35th Annual Symposium on Foundations of Computer Science, Santa Fe, NM, Nov. 20-22, 1994, IEEE Computer Society Press, pp. 124-134.

Lov K. Grover, A Fast Quantum Mechanical Algorithm for Database Search, Proceedings, STOC 1996, Philadelphia Pa., USA, pp. 212-219.

Donny Cheung et al., On the Design and Optimization of a Quantum Polynomial-Time Attack on Elliptic Curve Cryptography, Quantum Information & Computation, 9(7&8):610-621, July 2009.

Wenhua Li et al., Chaotic FH Codes for FH-SSMA Communications, Journal of China Institute of Communications, 1996.

### TECHNICAL FIELD

This invention relates generally to secure communication systems, and more specifically, to a post-quantum physical-layer encryption based on chaotic baseband modulation hopping.

### BACKGROUND OF THE INVENTION

Encryption is an important approach to secure communications. Traditional encryption algorithms include asymmetric and symmetric methods. Popular traditional asymmetric encryption algorithms consist of the Rivest-Shamir-Adleman (RSA) cryptosystem and Elliptic Curve Cryptography (ECC), and symmetric encryption algorithms include the Advanced Encryption Standard (AES), ZUC, and stream cipher.

Quantum computer can crack RSA and ECC completely with the Shor's quantum algorithm. The security strength of AES will be reduced half by Grover's quantum algorithm. In recent years, post-quantum cryptography is a hot research topic. A few non-quantum methods have been proposed in the literature which can survive the quantum computer attack, such as code-based cryptography, Hash-based cryptography, lattice-based cryptography, and multivariate quadratic equations cryptography. All these encryption algorithms are implemented in the digital domain.

Another post-quantum cryptography is based on quantum mechanism. Theoretically, any eavesdropping will be detected by the quantum cryptography system following the non-cloning theorem. Classical quantum cryptography, especially quantum key distribution (QKD), has a few limitations: (1) It cannot fight against the man-in-the-middle attack because of lack of mutual authentication; (2) Because of the hardware implementation limit, some backdoors may exist which can be utilized to find the quantum key.

Chaos theory studies the behavior of dynamical systems that are highly sensitive to initial conditions and chaotic system parameters. There are two kinds of chaotic dynamic systems: continuous and discrete. Chaos has been used to provide secure communications. For example, discrete chaotic map has been used to design Frequency Hopping (FH) codes, and Direct-Sequence-Spread-Spectrum (DSSS) codes. Chaotic signal can also be used as a non-sine carrier.

According to the International Organization for Standardization (OSI) model, encryption can be designed in both the above-physical layer and physical-layer. RSA, ECC, and AES are all processed in the digital domain, which is above the physical layer. QKD is a physical-layer asymmetric encryption approach. Other physical-layer secure communication systems include physical-layer scrambling and spread spectrum communications.

This invention proposes a new physical-layer symmetric encryption method which is suitable for all communication systems and can defend the quantum computer attack such as Shor's algorithm and Grover's algorithm. It can also be applied to help QKD against the man-in-the-middle attack.

### SUMMARY

This invention is related to secure communication systems, and more specifically, to a post-quantum physical-layer encryption based on chaotic baseband modulation hopping. The basic idea is that the baseband modulation such as constellation, mapping, power level, will vary symbol-by-symbol according to an assigned random sequence. We name this approach as Baseband Modulation Hopping (BMH). Chaotic dynamic systems such as discrete chaotic maps are applied to generate the BMH codes.

At the transmitter side, chaotic dynamic systems are first selected and pre-shared with the receiver (not just limited to chaotic systems. Other random sequence generators can also be applied in this invention). The pre-shared key is used as the chaotic dynamic system parameters and initial values. Because chaotic systems are extremely sensitive to its system parameters and initial values, tiny difference will generate two totally different chaotic random sequences. From the raw chaotic sequences, we can generate BMH random codes. One method is quantization-based. Another method is to select certain bits from the raw chaotic sequence. A baseband modulation library (BML) is designed in advance and pre-shared between the transmitter and the receiver. Each constellation/mapping approach is assigned a tag. For example, QAM is assigned “1”, and QPSK is assigned “2”. There are two baseband modulation hopping approaches: (1) The quantized chaotic random sequence and BML are used to generate the BMH code sequence while the user information is used as the modulation information; (2) The user information and BML are used to generate the BMH sequence code while the quantized chaotic sequence is used as the modulation information. Multiple chaotic sequences will be generated in parallel, and are used for constellation/mapping sequence code, scrambling sequence code, and power control sequence code.

At the receiver side, the pre-shared key and chaotic sequence generator (the same as in the transmitter side) are used to generate the BMH modulation sequence. Then the BMH demodulation module will recover the encoded user information. In the first approach, the chaotic BMH sequence code is used to determine the constellation/mapping for each symbol. Traditional demodulation techniques can be applied directly to decode the user information. In the second approach, because the user information is used to design the BMH sequence code, we cannot know the baseband modulation for each symbol in advance. The BMH demodulation module will de-code the constellation/mapping for each symbol by the known chaotic sequence. Then the user information is recovered from the de-coded BMH sequence.

The BMH physical-layer encryption can be combined with (1) digital-domain based encryption algorithms such as AES, code-based post-quantum cryptography; (2) other physical-layer secure communication techniques such as FH and DSSS; (3) QKD to provide mutual authenticated key distribution.

This invention can be applied to all kinds of communication systems including wireless (radio frequency, optical, quantum channel, sonar) and wire (optical fiber, power line, telephone line, wire quantum channel, etc.).

### BRIEF DESCRIPTION OF THE DRAWINGS

The present invention may be understood, by way of examples, to the following drawings, in which:

FIG. 1 is a top view of the chaotic BMH based post-quantum physical-layer encryption/decryption system.

FIG. 2 is one example of raw chaotic sequences generated by the logistic chaotic map.

FIG. 3 illustrates one example of quantized chaotic sequences generated from FIG. 2.

FIG. 4 shows the first signal constellation/mapping approach.

FIG. 5 shows the second signal constellation/mapping approach.

FIG. 6 shows the third signal constellation/mapping approach.

FIG. 7 shows the fourth signal constellation/mapping approach.

FIG. 8 shows the modulation module of the first chaotic BMH mode.

FIG. 9 illustrates the demodulation module of the first chaotic BMH mode.

FIG. 10 is the modulation module of the second chaotic BMH mode.

FIG. 11 illustrates the demodulation module of the second chaotic BMH mode.

FIG. 12 is the BMH with phase scrambling.

FIG. 13 is the BMH with random power control.

FIG. 14 is the combination of BMH and DS/FH.

FIG. 15 shows the multi-round BMH modulation based encryption/decryption.

FIG. 16 shows the channels suitable for BMH.

### DETAILED DESCRIPTION OF THIS INVENTION

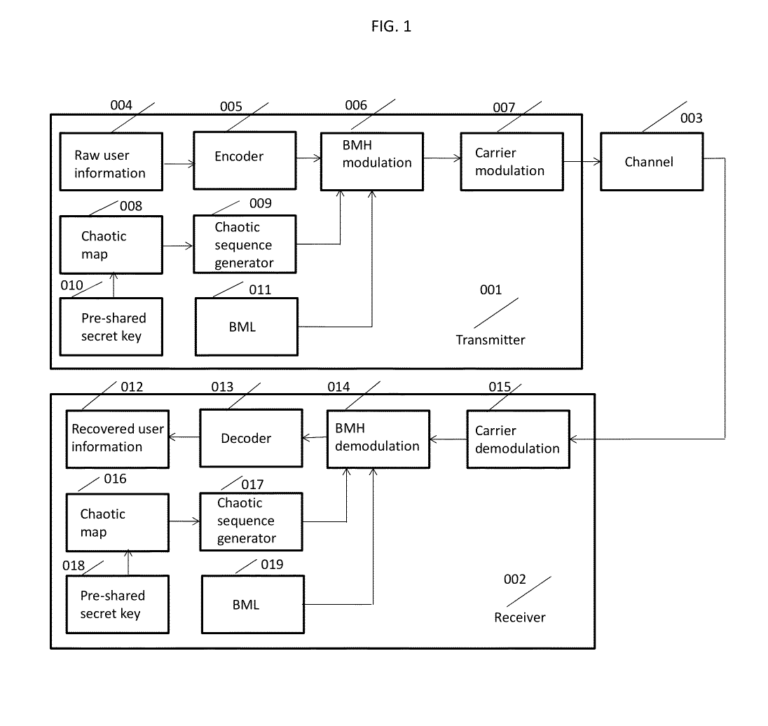

FIG. 1 shows the block diagram of a top view of the chaotic BMH based post-quantum physical-layer encryption/decryption system. There are three components: transmitter 001, receiver 002, and the channel 003.

The basic flowchart of the BMH encryption system is explained as follows. At the transmitter side 001, the raw user information 004 is first encoded 005 by digital-domain AES encryption, and/or channel encoding. Pre-shared key 010 is used as the chaotic system 008 parameters and initialization values. The chaotic sequence generator 009 generates a quantized chaotic sequence. The BML 011, chaotic sequence generator output and encoded user information are used as the input to the BMH modulation module 006. The BMH modulated information is input into the carrier module 007 and transmitted through the channel 003 to the receiver 002. At the receiver side 002, the received signal from the channel is first carrier de-modulated 015, then input into the BMH demodulation module 014. Pre-shared key 018 is used as the system parameters of the chaotic map 016. The chaotic sequence generator module 017 generates the chaotic sequences. The BMH demodulation module 014 recovers the encoded user information. The decode module 013 recovers the original user information 012.

There are a number of methods to formulate the chaotic systems. The first example is logistic map defined as

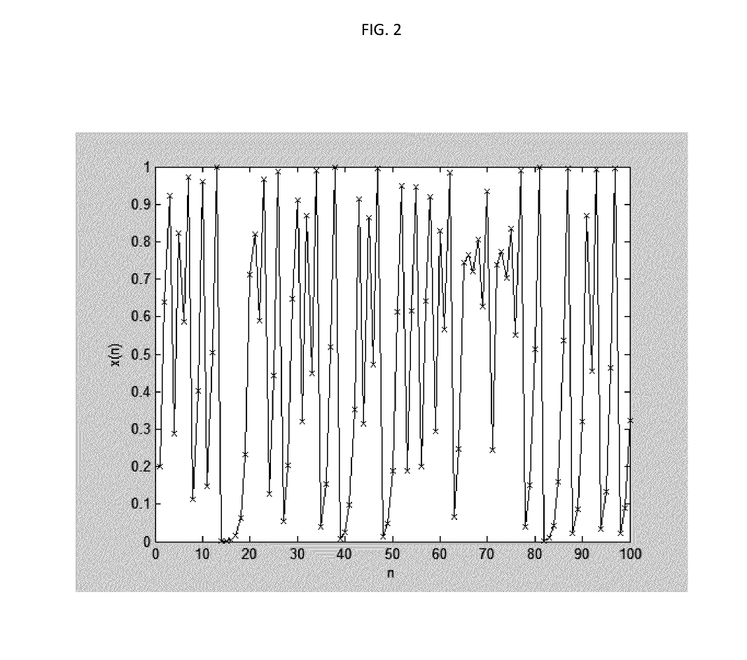

x(n+1)=r(n)*x(n)*(1−x(n)) (1)

where r(n) is the system parameter of the logistic map and x(1) is the initialization. FIG. 2 is one example of raw chaotic sequences generated by the logistic chaotic map. The second example is the Hennon map defined as

x(n+1)=1−a*x(n)*x(n)+y(n) (2)

y(n+1)=b*x(n) (3)

where a and b are the system parameters of the Hennon map and x(1) and y(1) are the initialization. The pre-shared key is used as x(1), y(1), a, b to generate the chaotic sequence. Multiple chaotic maps can be cascaded to formulate a hyper-chaotic system to generate more chaotic sequences at the same time.

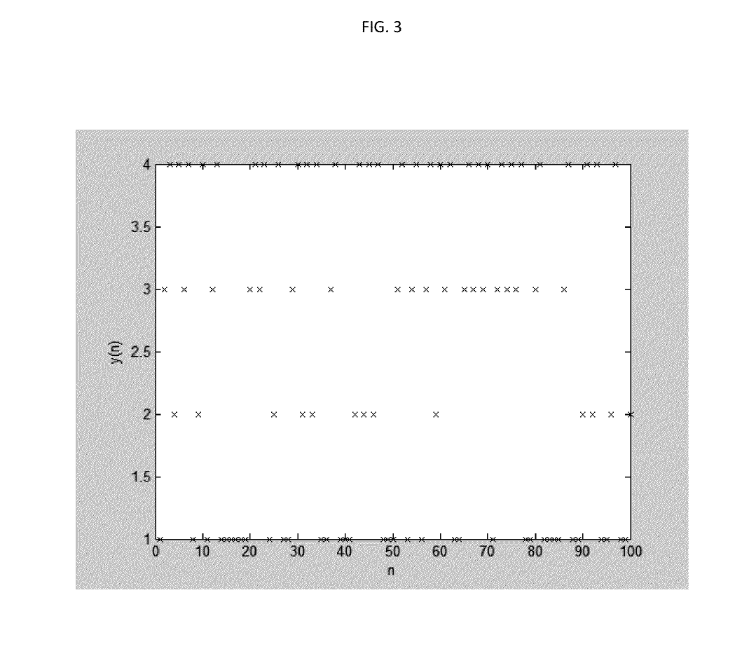

FIG. 3 illustrates one example of quantized chaotic sequences generated from FIG. 2. The raw chaotic sequence in FIG. 2 has values between (0, 1). The first method to generate the quantized chaotic sequence is through quantization. (0, 1) is divided into 4 intervals: (0, 0.25), (0.25, 0.50], (0.50, 0.75], (0.75, 1.00), which are tagged with 1, 2, 3, 4, respectively. In BML, each constellation/mapping has a special tag. From the BML and quantized chaotic sequence, the BMH random code is generated. The quantization values (0.25, 0.50, 0.75) are also used as the pre-shared key, together with the chaotic system parameters and initialization. This invention does not limit only the quantization method.

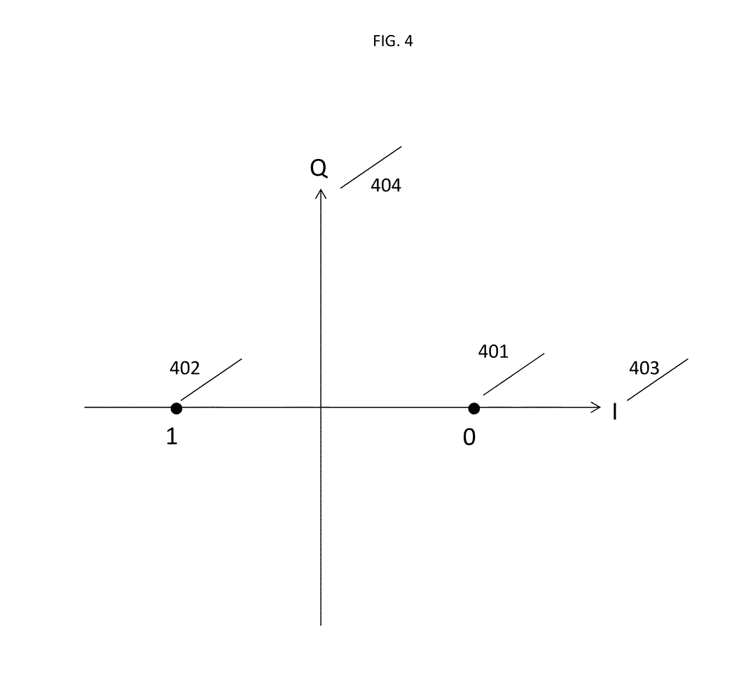

Various kinds of constellation/mapping can be used to set up the BML such as BPSK, QPSK, QAM, PPM. FIG. 4 shows the first signal constellation/mapping approach. It is a binary I/Q 403/404 constellation. 0 (401) and 1 (402) are mapped to (I=1, Q=0) and (I=−1, Q=0), respectively. This constellation/mapping is tagged with “1” in BML.

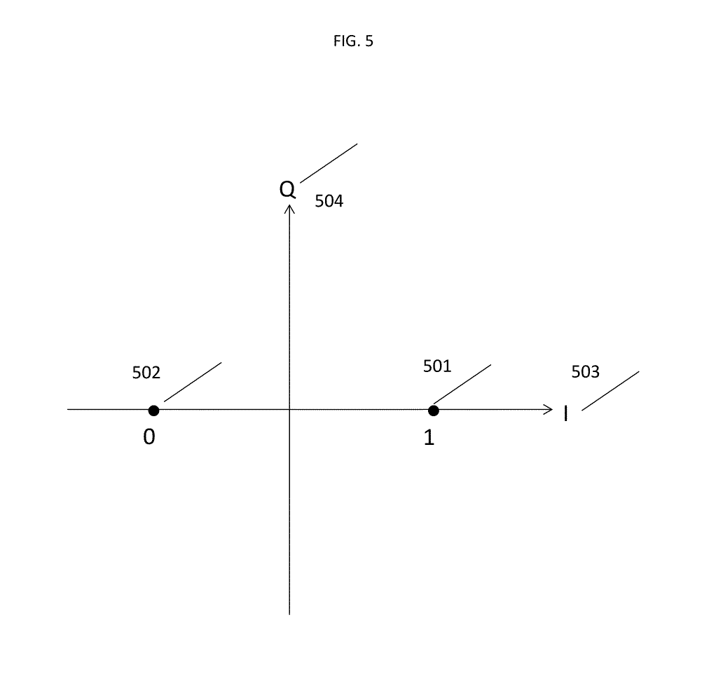

FIG. 5 shows the second signal constellation/mapping approach. It is a binary I/O 503/504 constellation. 0 (501) and 1 (502) are mapped to (I=−1, Q=0) and (I=1, Q=0), respectively. This constellation/mapping is tagged with “2” in the BML.

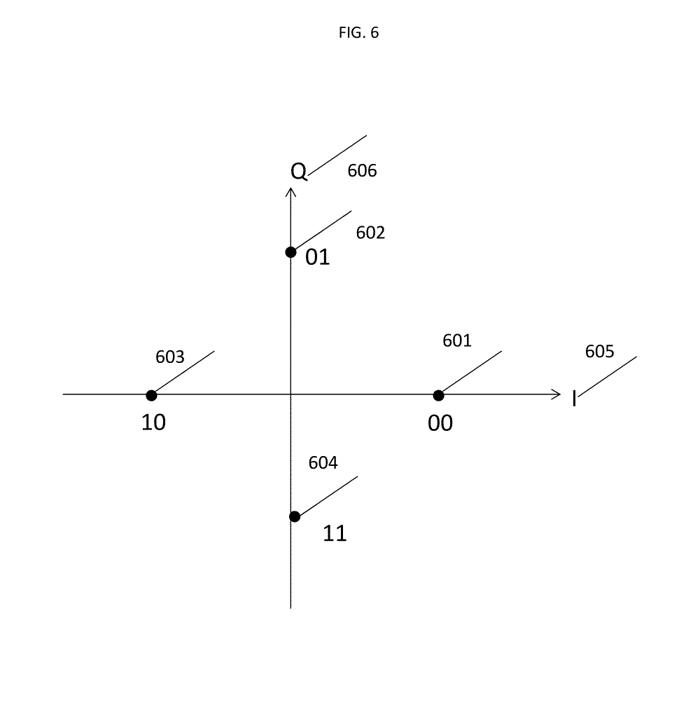

FIG. 6 shows the third signal constellation/mapping approach. It is a two-bit constellation/mapping. It is tagged as “3” in the BML. I (605)/Q (606) constellation is defined as 00 (601), 01 (602), 10 (603), 11 (604).

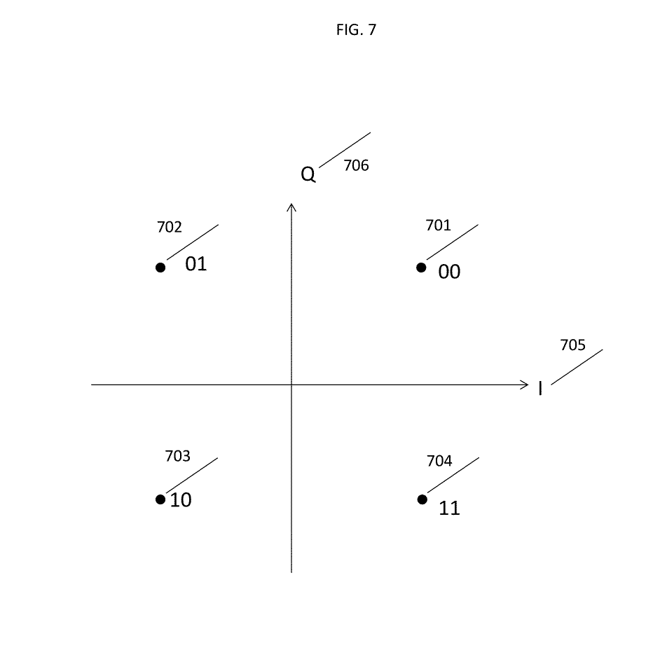

FIG. 7 shows the fourth signal constellation/mapping approach. It is two-bit constellation/mapping. It is tagged as “4” in the BML. I (705)/Q (706) constellation is defined as 00 (701), 01 (702), 10 (703), 11 (704).

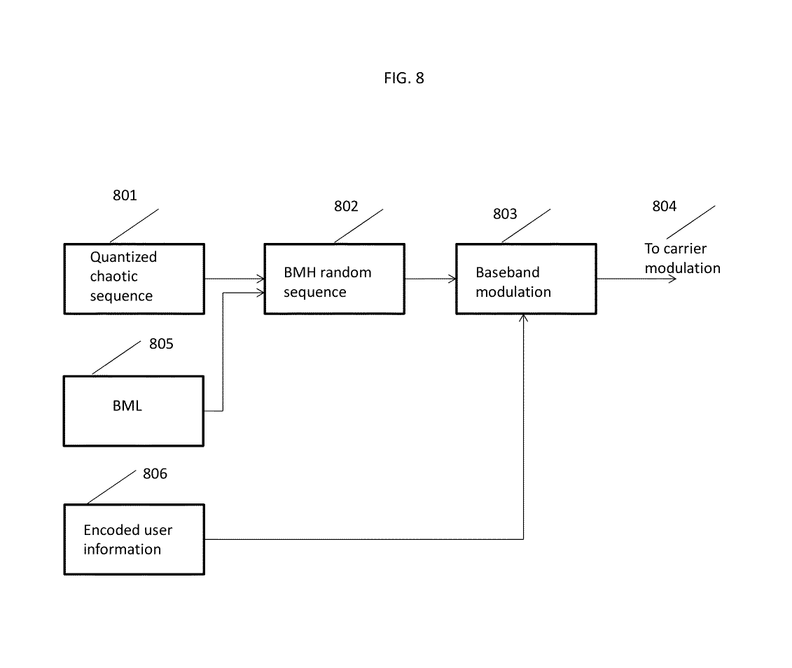

FIG. 8 shows the modulation module of the first chaotic BMH mode. The BMH random sequence module 802 utilizes the quantized chaotic sequence 801 and BML 805 to generate the random symbol-by-symbol constellation/mapping sequence. The baseband modulation module 803 modulates the user's information 806 by using the random symbol-by-symbol constellation/mapping from the module 802. The baseband modulated signal is then input into the carrier modulation module 804.

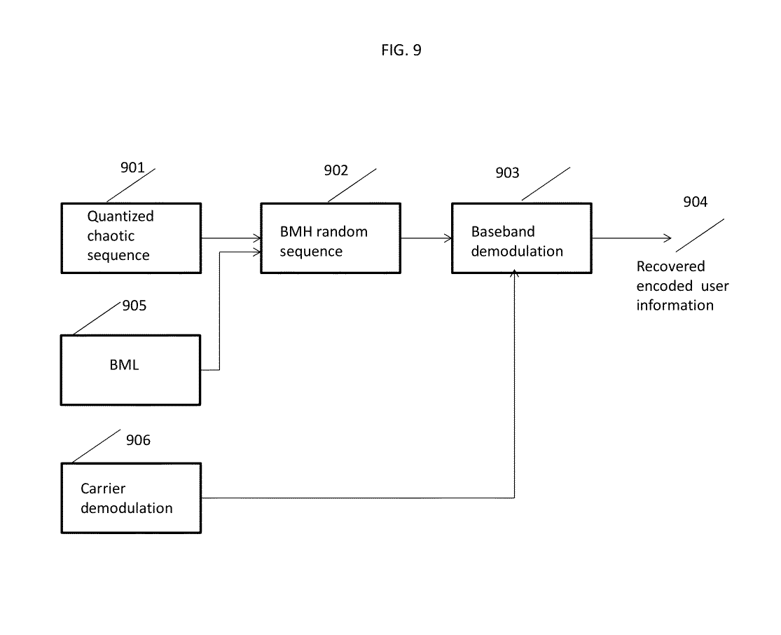

FIG. 9 illustrates the demodulation module of the first chaotic BMH mode. The same BMH modulation sequence as in the transmitter is generated through the baseband random sequence module 902, by using the quantized chaotic sequence module 901 and BML 905. The baseband demodulation module 903 and traditional carrier demodulation techniques 906 recover the user's information 904 symbol-by-symbol.

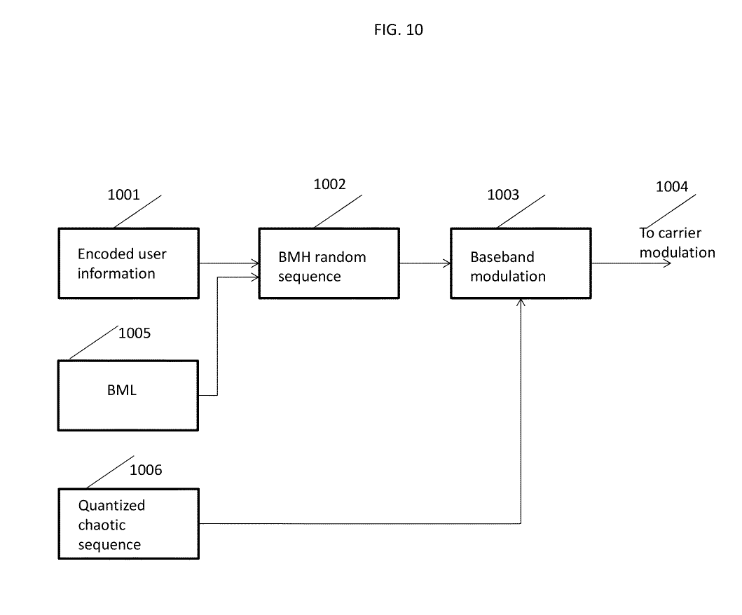

FIG. 10 is the modulation module of the second chaotic BMH mode. The difference between the first and second modes is how to assign the functions of the chaotic sequence and user's information. Unlike the first approach, in the second approach, the baseband random sequence module 1002 generates the random symbol-by-symbol constellation/mapping sequence by using the user's information 1001 and BML 1005. The baseband modulation module 1003 modulates the quantized chaotic sequence 1006. The final step is the carrier modulation module 1004.

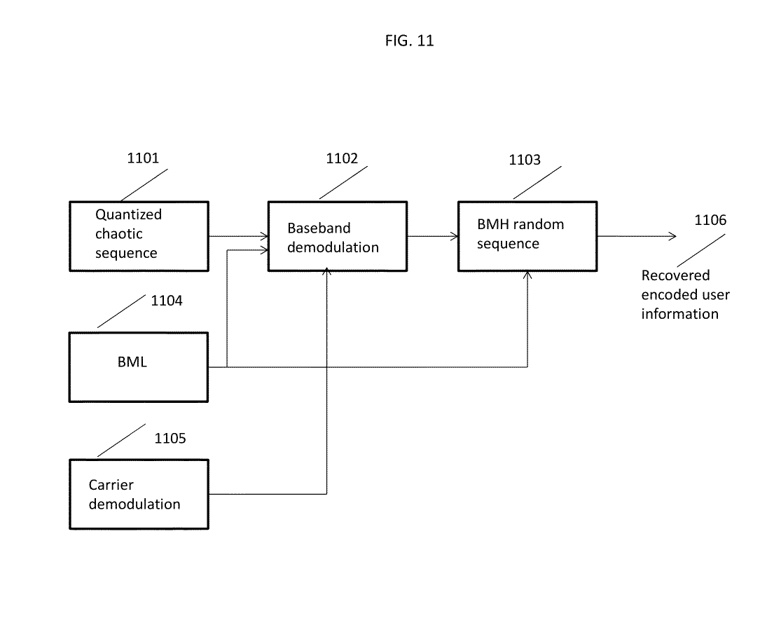

FIG. 11 illustrates the demodulation module of the second chaotic BMH mode. In the second approach, the modulated information (quantized chaotic sequence 1101) is computed from the pre-shared key. But the symbol-by-symbol constellation/mapping generated from the user information is not known. The baseband demodulation module 1102 cannot use the traditional communication baseband demodulation techniques. A Viterbi algorithm is designed to decode the symbol-by-symbol constellation/mapping tag defined in the BML 1104 after carrier demodulation 1105, and then the user information 1106 is recovered from the decoded constellation/mapping sequence.

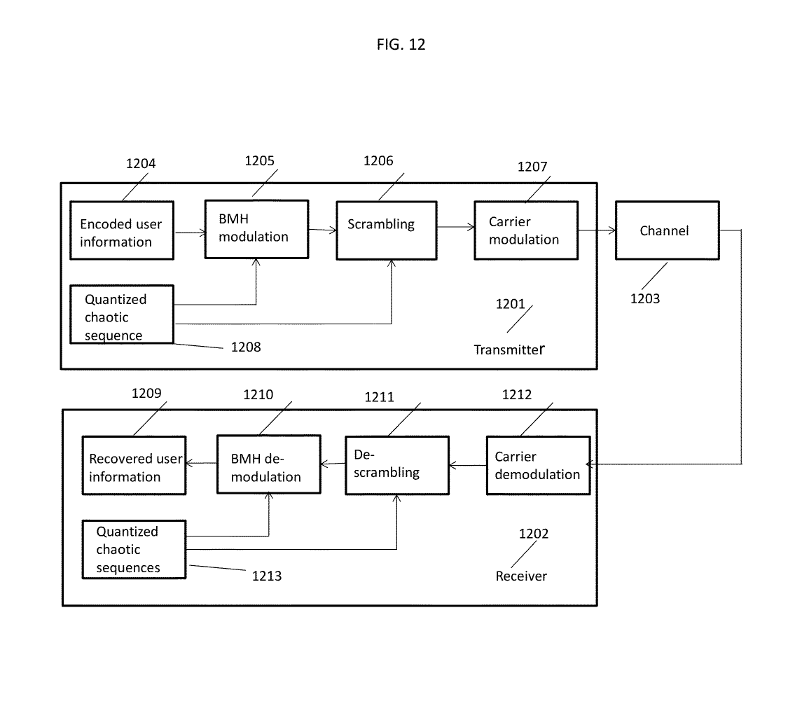

FIG. 12 is the BMH with phase scrambling. It is a combination of the first BMH (constellation/mapping based) approach and stream ciphering. At the transmitter side 1201, a special chaotic sequence 1208 is generated. A random phase generated from the chaotic sequence 1208 is multiplexed with the BMH modulation output 1205 of the encoded user information 1204 in the scrambling module 1206. Then the scrambled baseband modulation signal is input into the carrier modulation module 1207, and transmitted through channel 1203. At the receiver side 1202, the received carrier signal from the channel 1203 is first gone through the carrier demodulation module 1212. Then the de-scrambling module 1211 de-scrambles the random phase added to each symbol. Finally the baseband demodulation module 1210 recovers the user's information 1209 by using the quantized chaotic sequence 1213.

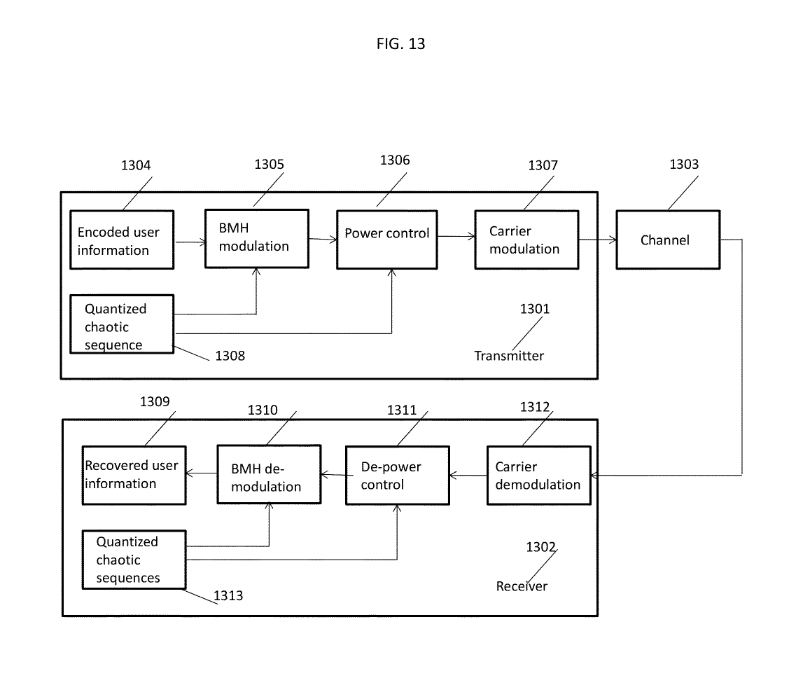

FIG. 13 is the BMH with random power control. Compared with the added random phase, a random power control is generated is generated in the power control module 1306. Other modules are the same as in FIG. 12. The transmitter 1301 has encoded user information 1304, BMH modulation 1305, power control 1306, quantized chaotic sequence 1308, and carrier modulation 1307. The modulated carrier signal is transmitted through channel 1303. The receiver 1302 has carrier demodulation 1312, de-power control 1311, BMH demodulation 1310, quantized chaotic sequence 1313, and recovered user information 1309.

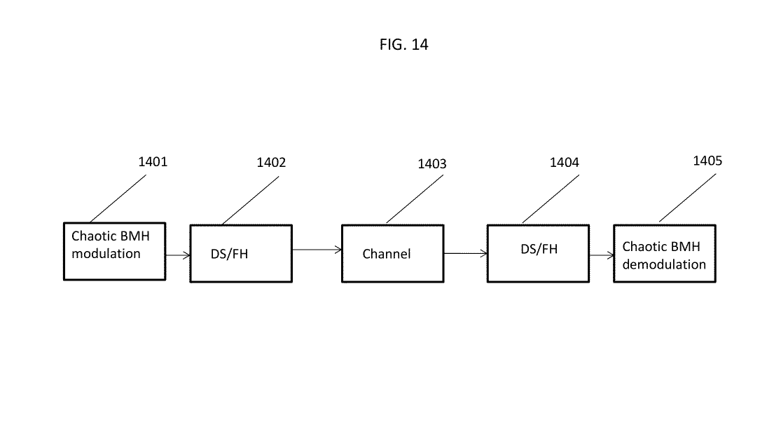

FIG. 14 is the combination of BMH and Discrete sequence (DS) and Frequency Hopping (FH). DS and FH are two popular spread spectrum techniques which provide secure communications. BMH can be combined with DS/FH to provide anti-jamming, secure communications. Chaotic BMH modulation 1401 is combined with DS/FH 1402. The modulated signal is transmitted through channel 1403. The receiver will demodulate DS/FH 1404 and then chaotic BMH 1405.

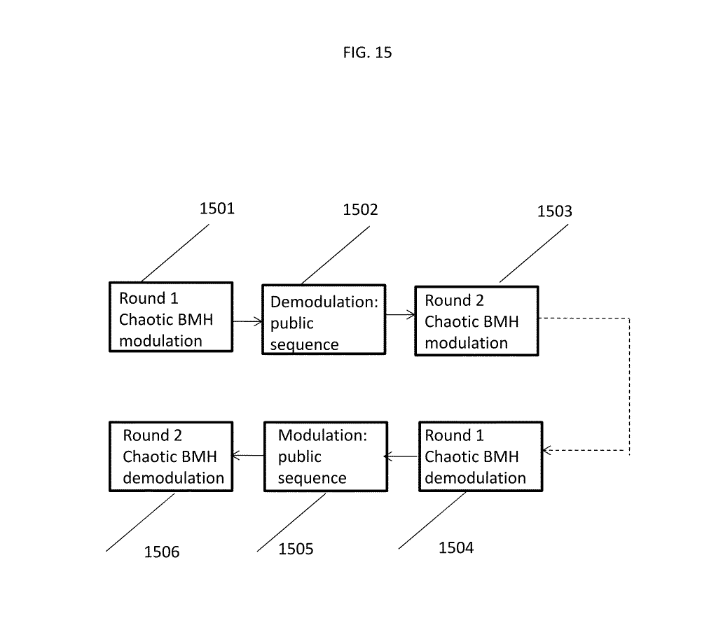

FIG. 15 shows the multi-round BMH modulation based encryption/decryption. At the transmitter side, after first-round chaotic BMH modulation 1501, a common constellation/mapping 1502 is used to demodulate the BMH signal, and then input into the second round BMH encryption 1503. At the receiver side, the second-round BMH signal is first demodulated 1504. Then the symbol-by-symbol constellation/mapping sequence is modulated by the public constellation/mapping 1505. Finally, the first-round BMH demodulation 1506 is applied to recover the user's information.

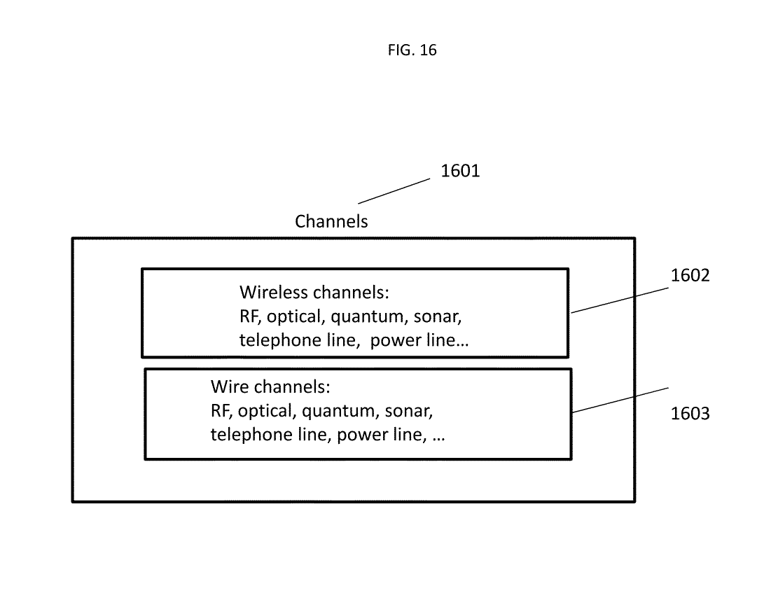

FIG. 16 shows the channels suitable for BMH. This invention is suitable for various wireless 1602 (radio frequency, optical, quantum, sonar, single carrier and multi-carrier, OFDM, MIMO, etc.) and wire communication channels 1603 (optical fiber, power line, telephone line, single carrier and multi-carrier, etc.).

What is claimed:

1. A post-quantum physical-layer encryption/decryption system based on chaotic Baseband Modulation Hopping (BMH) comprising:
chaotic BMH encryption at the transmitter side;
chaotic BMH decryption at the receiver side.

2. A post-quantum physical-layer encryption/decryption system based on chaotic BMH as in claim 1, wherein the encryption module at the transmitter side consists of pre-shared secret key, chaotic map, chaotic sequence generator, BMH modulation, and carrier modulation.

3. A post-quantum physical-layer encryption/decryption system based on chaotic BMH as in claim 1, wherein the decryption module at the receiver side consists of pre-shared secret key, chaotic map, chaotic sequence generator, BMH demodulation, and carrier demodulation.

4. A post-quantum physical-layer encryption/decryption system based on chaotic BMH as in claim 2, wherein the BMH code generation has the following steps:
pe-sharing secret keys between the transmitter and receiver;
selecting the chaotic dynamic systems which are pre-shared between the transmitter and the receiver;
determining the baseband modulation library (BML) including constellation/mapping, power level, scrambling phases;
pre-sharing the BML between the transmitter and the receiver;
using partial pre-shared keys as the chaotic system parameters and initializations to generate the raw random chaotic sequence;
using partial pre-shared keys as the quantization values to divide the raw chaotic sequence into some intervals;
tagging the quantized chaotic sequence with the BML to generate the random BMH code.

5. A post-quantum physical-layer encryption/decryption system based on chaotic BMH as in claim 2, wherein the BMH encryption has the following two approaches:
using the quantized chaotic sequence as the BMH code while the user information is used for modulation information;
using the user information to generate the BMH code while the quantized chaotic sequence is modulated.

6. A post-quantum physical-layer encryption/decryption system based on chaotic BMH as in claim 3, wherein the BMH decryption has the following two approaches:
using the quantized chaotic sequence as the BMH code while the user information is demodulation by variable baseband modulation symbol-by-symbol, in which traditional communication baseband demodulation technique is applied;
using the user information to generate the BMH code and the quantized chaotic sequence is used as modulation information.

7. A post-quantum physical-layer encryption/decryption system based on chaotic BMH as in claim 4, wherein the BMH encryption is combined with DS/FH secure communication systems.

8. A post-quantum physical-layer encryption/decryption system based on chaotic BMH as in claim 4, wherein the BMH encryption is combined with digital-domain encryption algorithms such as AES, RSA, ECC, code-based post-quantum cryptography, lattice post-quantum cryptography, Hash-based post-quantum cryptography, etc.

9. A post-quantum physical-layer encryption/decryption system based on chaotic BMH as in claim 4, wherein the BMH encryption is combined with quantum communication such as quantum key distribution and quantum direct communication to provide mutual authentication for defending the man-in-the-middle attack.

10. A post-quantum physical-layer encryption/decryption system based on chaotic BMH as in claim 4, wherein the BMH encryption is repeated a few times to formulate multi-round BMH encryption.

11. A post-quantum physical-layer encryption/decryption system based on chaotic BMH as in claim 1, wherein the BMH encryption can be applied to all communication channels including wireless (RF, optical, quantum, sonar, etc.), and wire (RF, optical, quantum, power-line, telephone line, etc.).

12. A post-quantum physical-layer encryption/decryption system based on chaotic BMH as in claim 1, wherein the BMH encryption can also be applied to variable-length block-cipher for data storage without communication.
